(19) United States
(12) Patent Application Publication
(10) Pub. No.: US 2026/0331706 A1
(43) Pub. Date: Oct. 22, 2026

(54) ALL-SOLID-STATE BATTERY

(71) Applicant: TDK Corporation, Tokyo (JP)

(72) Inventors: Shinya WATANABE, Tokyo (JP); Takehisa KATO, Tokyo (JP)

(73) Assignee: TDK Corporation, Tokyo (JP)

(21) Appl. No.: 19/108,533

(22) PCT Filed: Sep. 5, 2023
(86) PCT No.: PCT/JP2023/032423

§ 371 Date: Mar. 4, 2025

(30) Foreign Application Priority Data
Sep. 5, 2022 (JP) 2022-140495

(51) Int. Cl. H01M 50/474; H01M 10/0525; H01M 10/0585; H01M 50/105

(52) U.S. Cl. CPC H01M 50/474; H01M 10/0525; H01M 10/0585; H01M 50/105

(57) ABSTRACT

An all-solid-state battery includes: an exterior body including a laminated body having a positive electrode active material layer, a solid electrolyte layer, and a negative electrode active material layer laminated in this order, positive and negative electrode current collectors sandwich the laminated body in a lamination direction, an insulation sheet between the positive and negative electrode current collectors in an in-plane direction with respect to the laminated body, a first adhesive sheet between the insulation sheet and the positive electrode current collector and to which at least a part of the insulation sheet and positive electrode current collector is bonded, and a second adhesive sheet between the insulation sheet and negative electrode current collector and to which at least a part of the insulation sheet and negative electrode current collector is bonded, in which the laminated body and exterior body are communicating with respect to each other.

### TECHNICAL FIELD

The present invention relates to an all-solid-state battery.

Priority is claimed on Japanese Patent Application No. 2022-140495, filed Sep. 5, 2022, the content of which is incorporated herein by reference.

### BACKGROUND ART

In recent years, the development of electronics technology has been remarkable, and portable electronic devices have been made smaller, lighter, thinner, and multifunctional. Accordingly, there is a strong demand for batteries being power sources for electronic devices to be smaller, lighter, thinner, and more reliable. Under these circumstances, all-solid-state batteries using solid electrolytes as electrolytes as disclosed in Patent Documents 1 and 2 have been attracting attention.

The all-solid-state battery disclosed in Patent Document 1 is provided with a plurality of element portions in which a positive electrode layer, a solid electrolyte layer, and a negative electrode layer are laminated in this order, and both end surfaces of the plurality of element portions in the lamination direction are in contact with a first conductive layer and a second conductive layer, respectively, which extend in the in-plane direction. In the all-solid-state battery disclosed in Patent Document 1, the side surface of the element portions (laminated body) is surrounded by a frame, and the end surfaces in the lamination direction are in contact with the conductive layers as described above. In other words, in the all-solid-state battery disclosed in Patent Document 1, the element portions are surrounded by other members over the entire surface.

The all-solid-state battery disclosed in Patent Document 2 has a positive electrode active material layer, a solid electrolyte layer, a negative electrode active material layer, and current collector plates sandwiching the layers in the lamination direction, and it is disclosed in Patent Document 2 that a cylindrical insulating frame placed closely to side surfaces of the current collector plates is provided. A cylindrical insulating frame is used when manufacturing an all-solid-state battery, materials used as a positive electrode layer, a negative electrode layer, and a solid electrolyte layer are housed inside the cylindrical insulating frame, and these are pressed in the lamination direction to manufacture an all-solid-state battery. It is disclosed in Patent Document 2 that, at this time, the materials of the positive electrode layer and the negative electrode layer enter between the current collector plates and the insulating frame located at the end portions in the lamination direction, and the airtightness between the current collector plates and the insulating frame is ensured.

### CITATION LIST

### Patent Document

Patent Document 1: Japanese Unexamined Patent Application, First Publication No. 2015-76182
Patent Document 2: Japanese Unexamined Patent Application, First Publication No. 2011-159635

### SUMMARY OF INVENTION

### Technical Problem

However, when assembling an all-solid-state battery as disclosed in Patent Documents 1 and 2, even when it is carried out in a dry room, there may be a case where gases such as atmospheric air and a trace amount of water (water vapor) are sealed together with a laminated body in other members.

When atmospheric air is sealed together with the laminated body in other members, air accumulates between the laminated body and the conductive layers and the interface between the laminated body and the conductive layers is opened, resulting in poor joining between the laminated body and the conductive layers and increased internal resistance between the laminated body and a current collector. In addition, there is also a concern of a decrease in battery capacity.

When water is sealed together with the laminated body, there is a concern that it may react with a sulfide-based solid electrolyte or a halide-based solid electrolyte contained in a solid electrolyte layer during charging and discharging to generate hydrogen sulfide or hydrogen chloride gas. The generation of such gases is significant at high temperatures. If a by-product gas such as hydrogen sulfide or hydrogen chloride is generated in a sealed space, there is a concern that the joining between the laminated body and the current collector may become poor and the internal resistance between the laminated body and the current collector may become large. In addition, it is necessary to avoid the generation of toxic hydrogen sulfide.

The present invention has been made from the viewpoint of the above-described circumstances, and an object of the present invention is to provide an all-solid-state battery capable of suppressing an increase of internal resistance between a laminated body and a current collector.

### Solution to Problem

(1) An all-solid-state battery according to one aspect of the present invention includes: an exterior body which includes a laminated body in which a positive electrode active material layer, a solid electrolyte layer, and a negative electrode active material layer are laminated in this order, a positive electrode current collector and a negative electrode current collector that sandwich the laminated body in a lamination direction, an insulation sheet that is positioned between the positive electrode current collector and the negative electrode current collector and is positioned in an in-plane direction with respect to the laminated body, a first adhesive sheet that is positioned between the insulation sheet and the positive electrode current collector and to which at least a part of the insulation sheet and the positive electrode current collector is bonded, and a second adhesive sheet that is positioned between the insulation sheet and the negative electrode current collector and to which at least a part of the insulation sheet and the negative electrode current collector is bonded, in which the laminated body and the exterior body are communicating with respect to each other.
(2) In the all-solid-state battery of (1) above, at least one void may be formed in an insulation unit configured to have the first adhesive sheet, the insulation sheet, and the second adhesive sheet, and the laminated body and the exterior body may be communicating with respect to each other through the void(s).
(3) In the all-solid-state battery of (1) or (2) above, the void may be formed in at least one of the first adhesive sheet and the second adhesive sheet.
(4) In the all-solid-state battery according to any one of (1) to (3) above, two voids may be formed in the insulation unit, and the two voids may be provided at non-overlapping positions when viewed in a plan view in the lamination direction.
(5) In the all-solid-state battery according to any one of (1) to (4) above, four voids may be formed in the insulation unit, and the four voids may be provided at non-overlapping positions when viewed in a plan view in the lamination direction.
(6) In the all-solid-state battery according to any one of (1) to (5) above, the width of the void may be smaller than the minimum width of the laminated body when viewed in a plan view in the lamination direction.
(7) In the all-solid-state battery according to any one of (1) to (6) above, the first adhesive sheet and the second adhesive sheet may be provided along an end surface of the insulation sheet on a side close to the laminated body.
(8) In the all-solid-state battery according to any one of (1) to (7) above, the voids may be formed in the first adhesive sheet, the insulation sheet, and the second adhesive sheet at overlapping positions when viewed in a plan view in the lamination direction.
(9) In the all-solid-state battery according to any one of (1) to (8) above, the first adhesive sheet may include a plurality of adhesive sheets provided apart from each other in different orientations with respect to the laminated body, and the second adhesive sheet may include a plurality of adhesive sheets provided apart from each other in different orientations with respect to the laminated body.
(10) In the all-solid-state battery according to any one of (1) to (9) above, a space between the positive electrode current collector and the negative electrode current collector in a region overlapping the first adhesive sheet may be smaller than a space between the positive electrode current collector and the negative electrode current collector in a region overlapping the laminated body.
(11) In the all-solid-state battery according to any one of (1) to (10) above, the first adhesive sheet and the insulation sheet may surround a periphery of the laminated body in the in-plane direction, and in the plan view from the lamination direction of the laminated body, a shape of an inner circumference of the insulation sheet on the side close to the laminated body may be similar to or congruent with a shape of an inner circumference of any of the first adhesive sheet or the second adhesive sheet on the side close to the laminated body.
(12) In the all-solid-state battery according to any one of (1) to (11) above, the first adhesive sheet, the second adhesive sheet, and the insulation sheet may surround the periphery of the laminated body in the in-plane direction, and when viewed in the lamination direction of the laminated body, the dimensions of the inner circumference of the first adhesive sheet and the second adhesive sheet surrounding the laminated body may be less than or equal to the dimensions of the inner circumference of the insulation sheet surrounding the laminated body.
(13) In the all-solid-state battery according to the above-described aspect, the relationship between a thickness T40 of the insulation sheet and a total thickness T45 of the insulation sheet, the first adhesive sheet, and the second adhesive sheet may satisfy Expression [1] below.

$$0.3 \leq T 40 / T 45 \leq 0 \text{.96} \qquad [ 1 ]$$

(14) In the all-solid-state battery according to the above-described aspect, the ratio T51/T52 of a thickness T51 of the first adhesive sheet to a thickness T52 of the second adhesive sheet may satisfy a relationship of Expression [2] below.

$$0.15 \leq T 51 / T 52 \leq 7 \qquad [ 2 ]$$

(15) In the all-solid-state battery according to the above-described aspect, the thickness T51 of the first adhesive sheet may be 4 to 110 μm.
(16) In the all-solid-state battery according to the above-described aspect, the thickness T52 of the second adhesive sheet may be 4 to 110 μm.

### Advantageous Effects of Invention

According to the present invention, it is possible to provide an all-solid-state battery capable of suppressing an increase in internal resistance between a laminated body and a current collector.

### BRIEF DESCRIPTION OF DRAWINGS

FIG. 1 A perspective view showing an example of a configuration of an all-solid-state battery according to one embodiment of the present invention.

FIG. 2 A cross-sectional view of the all-solid-state battery of FIG. 1 which is cut along the lamination direction.

FIG. 3 A plan view of the all-solid-state battery of FIG. 1 when viewed in the lamination direction.

FIG. 4 A cross-sectional view of an all-solid-state battery according to one embodiment of the present invention which is cut along the lamination direction.

FIG. 5 A cross-sectional view of an all-solid-state battery according to another embodiment of the present invention which is cut along the lamination direction.

FIG. 6 A plan view of the all-solid-state battery of FIG. 5 when viewed in the lamination direction.

FIG. 7 A cross-sectional view of the all-solid-state battery according to still another embodiment of the present invention which is cut along the lamination direction.

FIG. 8 A plan view of the all-solid-state battery of FIG. 7 when viewed in the lamination direction.

FIGS. 9(a) and 9(b) Plan views of all-solid-state batteries according to modification examples of FIG. 3 when viewed in the lamination direction.

FIG. 10 A cross-sectional view of an all-solid-state battery according to still another embodiment of the present invention which is cut along the lamination direction.

FIG. 11 A plan view of the all-solid-state battery of FIG. 10 when viewed in the lamination direction.

FIG. 12 A cross-sectional view of an all-solid-state battery according to still another embodiment of the present invention which is cut along the lamination direction.

FIG. 13 A plan view of the all-solid-state battery of FIG. 12 when viewed in the lamination direction.

FIGS. 14(a) to 14(c) Plan views of all-solid-state batteries according to modification examples of FIG. 13 when viewed in the lamination direction.

FIGS. 15(a) to (c) Plan views of all-solid-state batteries according to still other embodiments of the present invention when viewed in the lamination direction.

FIGS. 16(a) to (c) Plan views of all-solid-state batteries according to still other embodiments of the present invention when viewed in the lamination direction.

FIG. 17 Charge/discharge curves of Example 1 and Comparative Example 1.

FIGS. 18(a) and 18(b) States after a battery capacity test and an internal resistance test of all-solid-state batteries of Example 1 and Comparative Example 1.

FIG. 19 Charge/discharge curves of Example 2 and Comparative Example 2.

### DESCRIPTION OF EMBODIMENTS

Hereinafter, an example of embodiments of the present invention will be described in detail with reference to the accompanying drawings. In the drawings used in the following description, a part that becomes a feature of the present invention is sometimes enlarged for convenience in order to allow the feature to be easily understood. Therefore, the dimensional ratios of each constituent element and the like are sometimes different from the actual ones.

### [All-Solid-State Battery]

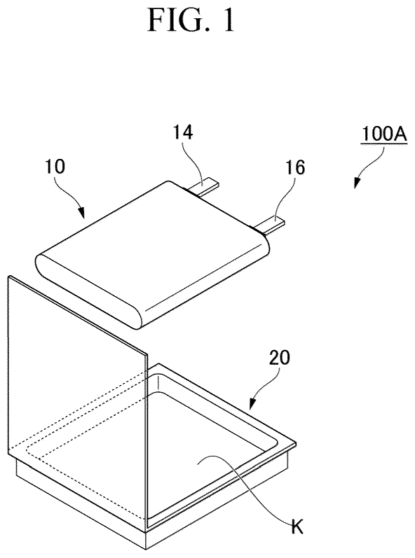

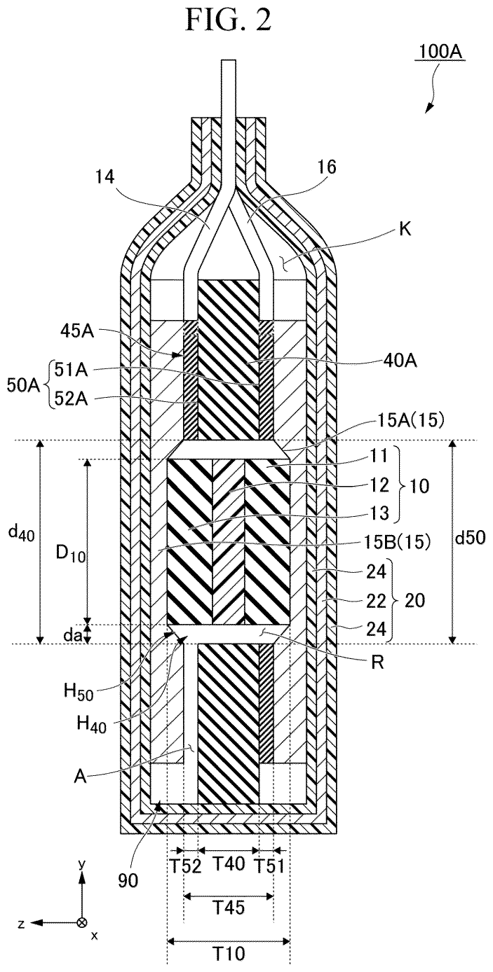

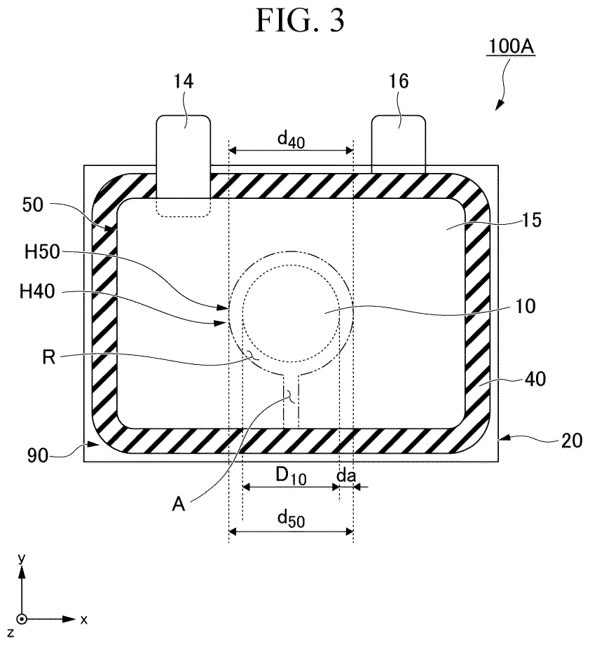

FIG. 1 is a perspective view showing an example of a configuration of an all-solid-state battery according to one embodiment of the present invention. FIG. 2 is a cross-sectional view of the all-solid-state battery of FIG. 1 which is cut along the lamination direction. FIG. 3 is a plan view of the all-solid-state battery of FIG. 1 when viewed in the lamination direction.

The all-solid-state battery 100A shown in FIGS. 1 to 3 includes an exterior body 20 and an electrical storage element 90 housed in a housing space K in the exterior body 20. FIG. 1 shows a state immediately before the electrical storage element 90 is housed in the exterior body 20 to facilitate understanding.

### {Exterior Body}

The exterior body 20 includes, for example, a metal foil 22 and resin layers 24 laminated on both surfaces of the metal foil 22 (refer to FIG. 2). The exterior body 20 is a metal laminated film obtained by coating both sides of the metal foil 22 with polymer films (resin layers). The metal foil 22 is, for example, aluminum foil. The resin layers 24 are, for example, polymer films of such as polypropylene. The inner and outer resin layers 24 may be different from each other. For example, polyethylene terephthalate (PET) and polyamide (PA) having a high melting point can be used for the outer resin layer, and polyethylene (PE), polypropylene (PP), and the like having high heat resistance, oxidation resistance, and reduction resistance can be used for the inner resin layer.

### {Electrical Storage Element}

The electrical storage element 90 includes a laminated body 10, a positive electrode current collector 15A, a negative electrode current collector 15B, an insulation sheet 40, a first adhesive sheet 51A, and a second adhesive sheet 52A. Hereinafter, when the positive electrode current collector 15A and the negative electrode current collector 15B are not distinguished, they may simply be referred to as a current collector 15. In addition, hereinafter, when the first adhesive sheet 51A and the second adhesive sheet 52A are not distinguished, they may simply be referred to as an adhesive sheet 50A. In addition, although only a reference numeral 50A may be shown in the plan view, the arrangement in the laminated structure is as shown in the cross-sectional view. The first adhesive sheet 51A, an insulation sheet 40A, and the second adhesive sheet 52A constitute an insulation unit 45A.

### <Current Collector>

The positive electrode current collector 15A and the negative electrode current collector 15B extend in an in-plane direction intersecting with the z-direction. The positive electrode current collector 15A and the negative electrode current collector sandwich the laminated body 10 in the z-direction. In FIGS. 2 and 3, the width of the current collector 15 in the x-direction is indicated by W15 and the length thereof in the y-direction is indicated by L15.

The positive electrode current collector 15A and the negative electrode current collector 15B are composed of, for example, a material having high conductivity. The positive electrode current collector 15A and the negative electrode current collector 15B are, for example, metals such as silver, palladium, gold, platinum, aluminum, copper, nickel, titanium, stainless steel, and their alloys, or conductive resins. The same material or different materials may be used for the positive electrode current collector 15A and the negative electrode current collector 15B. In addition, although examples of the positive electrode current collector 15A and the negative electrode current collector 15B having the same size were shown in FIGS. 2 and 3, the size thereof may be different from each other.

### <Laminated Body>

In the laminated body 10, a positive electrode active material layer 11, a solid electrolyte layer 12, and a negative electrode active material layer 13 are laminated in this order in the z-direction. The laminated body 10 is placed between the positive electrode current collector 15A and the negative electrode current collector 15B. The laminated body 10 is housed in, for example, through-holes H40 and H50 to be described below in the in-plane direction of the positive electrode active material layer 11. In the present embodiment, the space corresponding to the through-holes H40 and H50 may be referred to as a housing portion when viewed in a plan view. The laminated body 10 and the exterior body 20 are communicating with respect to each other. The laminated body 10 and the exterior body 20 are communicating with respect to each other through a void A formed in the insulation unit 45A to be described below, for example. In other words, the void A can be said to be a path connecting a plurality of voids.

The plan view shape of the laminated body 10 is, for example, circular. In the present embodiment, the outer dimension of the laminated body 10 when viewed in a plan view in the z-direction is indicated by D10, and the thickness of the laminated body 10 in the z-direction is indicated by T10.

The laminated body 10 exchanges electrons with the positive electrode current collector 15A and the negative electrode current collector 15B and exchanges lithium ions through the solid electrolyte layer 12. The all-solid-state battery 100A is charged or discharged by the laminated body 10 by exchanging electrons and lithium ions.

### (Positive Electrode Active Material Layer)

The positive electrode active material layer 11 is on the positive electrode current collector 15A of the solid electrolyte layer 12. The positive electrode active material layer 11 contains a positive electrode active material, and as necessary, may contain a conductive assistant, a binder, and a solid electrolyte to be described below.

The positive electrode active material contained in the positive electrode active material layer 11 is, for example, a lithium-containing transition metal oxide, a transition metal fluoride, a polyanion, a transition metal sulfide, a transition metal oxyfluoride, a transition metal oxysulfide, and a transition metal oxynitride.

The positive electrode active material is not particularly limited as long as it can reversibly progress release and absorption of lithium ions and desorption and insertion of lithium ions. For example, positive electrode active materials used in well-known lithium ion secondary batteries can be used.

Specific examples of positive electrode active materials include lithium cobaltate (LiCoO₂), lithium nickelate (LiNiO₂), lithium manganese spinel (LiMn₂O₄), composite metal oxides represented by general formula: LiNiₓCo_{y}Mn_{z}MₐO₂ (x+y+z+a=1, 0≤x≤1, 0≤y≤1, 0≤z≤1, 0≤a≤1, and M is one or more kinds of elements selected from Al, Mg, Nb, Ti, Cu, Zn, and Cr), lithium vanadium compounds (LiV₂O₅, Li₃V₂(PO₄)₃, and LiVOPO₄), olivine-type LiMPO₄ (where M represents one or more kinds of elements selected from Co, Ni, Mn, Fe, Mg, V, Nb, Ti, Al, and Zr), lithium titanate (Li₄Ti₅O₁₂), and composite metal oxides such as LiNiₓCo_{y}Al_{z}O₂ (0.9<x+y+z<1.1).

In addition, if a negative electrode active material doped with metallic lithium or lithium ions is placed in a negative electrode in advance, a positive electrode active material that does not contain lithium can also be used by starting the battery from discharging. Examples of positive electrode active materials include lithium-free metal oxides (such as MnO₂ and V₂O₅), lithium-free metal sulfides (such as MoS₂), and lithium-free fluorides (such as FeF₃ and VF₃).

### (Negative Electrode Active Material Layer)

The negative electrode active material layer 13 is on the negative electrode current collector 15B of the solid electrolyte layer 12. The negative electrode active material layer 13 contains a negative electrode active material, and as necessary, may contain a conductive assistant, a binder, and a solid electrolyte to be described below.

The negative electrode active material contained in the negative electrode active material layer 13 may be a compound capable of absorbing and releasing mobile ions, and negative electrode active materials used in well-known lithium ion secondary batteries can be used. Examples of negative electrode active materials include alkali metal simple substances, alkali metal alloys, graphite (natural graphite and artificial graphite), carbon materials such as carbon nanotubes, hardly graphitized carbon, easily graphitized carbon, and low temperature calcined carbon, metals that can combine with metals such as alkali metals such as aluminum, silicon, tin, germanium and their alloys, SiOₓ (0<x<2), oxides such as iron oxide, titanium oxide, and tin dioxide, and lithium metal oxides such as lithium titanate (Li₄Ti₅O₁₂).

Conductive assistants that the positive electrode active material layer 11 and the negative electrode active material layer 13 can contain are not particularly limited as long as they provide favorable electronic conductivity of the positive electrode active material layer 11 and the negative electrode active material layer 13, and well-known conductive assistants can be used. Examples of conductive assistants include carbon-based materials such as graphite, carbon black, graphene, and carbon nanotubes, metals such as gold, platinum, silver, palladium, aluminum, copper, nickel, stainless steel, and iron, conductive oxides such as ITO, or mixtures thereof. The conductive assistant may be in powder or fiber form.

### (Binder)

A binder joins the positive electrode current collector 15A and the positive electrode active material layer 11, the negative electrode current collector 15B and the negative electrode active material layer 13, the positive electrode active material layer 11, the negative electrode active material layer 13, and the solid electrolyte layer 12, a variety of materials that configure the positive electrode active material layer 11 together, and a variety of materials that configure the negative electrode active material layer 13 together.

A binder is used, for example, within a range that does not impair the functions of the positive electrode active material layer 11 and the negative electrode active material layer 13. The binder can be anything that enables the joining described above, and examples thereof include fluororesins such as polyvinylidene fluoride (PVDF) and polytetrafluoroethylene (PTFE). Furthermore, in addition to the above, cellulose, styrene-butadiene rubber, ethylene-propylene rubber, a polyimide resin, and a polyamideimide resin may be used as binders. In addition, a conductive polymer having electron conductivity and an ion-conductive polymer having ionic conductivity may be used as a binder. Examples of conductive polymers having electron conductivity include polyacetylene. In this case, since the binder also exhibits the function of conductive assistant particles, a conductive assistant may not be incorporated. As ion-conductive polymers having ionic conductivity, for example, those that conduct lithium ions and the like can be used, and examples thereof include those obtained by combining monomers of polymer compounds (polyether polymer compounds such as polyethylene oxide and polypropylene oxide, and polyphosphazene), with lithium salts such as LiClO₄, LiBF₄, LiPF₆, LiTFSI, and LiFSI or alkali metal salts mainly composed of lithium. Polymerization initiators used for combination include thermal polymerization initiators or photopolymerization initiators compatible with the above-described monomers. Examples of properties required for binders include oxidation-reduction resistance and favorable adhesiveness. If the binders are unnecessary, these may not be incorporated.

The content of a binder in the positive electrode active material layer 11 is not particularly limited, but is preferably 0.5 to 30 volume % of the positive electrode active material layer from the viewpoint of lowering the resistance of the positive electrode active material layer 11. In addition, the content of a binder in the positive electrode active material layer 11 is preferably 0 volume % from the viewpoint of improving the energy density.

The content of a binder in the negative electrode active material layer 13 is not particularly limited but is preferably 0.5 to 30 volume % of the negative electrode active material layer from the viewpoint of lowering the resistance of the negative electrode active material layer 13. In addition, the content of a binder in the negative electrode active material layer 13 is preferably 0 volume % from the viewpoint of improving the energy density.

### (Solid Electrolyte Layer)

The solid electrolyte layer 12 is positioned between the positive electrode active material layer 11 and the negative electrode active material layer 13. The solid electrolyte layer 12 contains a solid electrolyte. A solid electrolyte is a substance (for example, particles) in which ions can be moved by an externally applied electric field. In addition, the solid electrolyte layer is an insulator that inhibits movement of electrons.

The solid electrolyte contains, for example, lithium. The solid electrolyte may be, for example, any halide-based materials such as compositions represented by Formula [3] below or any sulfide-based materials such as Li_{3.25}Ge_{0.25}P_{0.75}S₄.

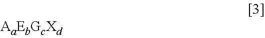

(In Formula [3], A is at least one element selected from Li and Cs, E is at least one element selected from the group consisting of Al, Sc, Y, Zr, Hf, and lanthanoid, G is at least one group selected from the group consisting of OH, BO₂, BO₃, BO₄, B₃O₆, B₄O₇, CO₃, NO₃, ALO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂S₆, S₂O₇, S₂O₈, BF₄, PF₆, and BOB, X is at least one element selected from the group consisting of F, Cl, Br, and I, 0.5≤a<6, 0<b<2, 0≤c≤6, and 0≤d≤6.1.)

The solid electrolyte may be, for example, any of a thio-LISICON-type compound and a glass compound. Li_{3.25}Ge_{0.25}P_{0.75}S₄ and Li₃PS₄ are examples of thio-LISICON-type compounds. Li₂S—P₂S₅ is an example of a glass compound. Any material that can be used in a compacted powder-type powder molding method of the pressure powder type can be used as the solid electrolyte. The solid electrolyte may contain one or more kinds of these compounds.

The solid electrolyte layer 12 may contain a substance other than the solid electrolyte material. For example, the solid electrolyte layer 12 may contain a sulfide or halide of an alkali metal element or a sulfide or halide of a transition metal element. In addition, the solid electrolyte layer 12 may contain a binder. The binder is the same as described above.

### (Insulation Sheet)

The insulation sheet 40 is positioned between the positive electrode current collector 15A and the negative electrode current collector 15B and positioned in the in-plane direction with respect to the laminated body 10. The insulation sheet 40 extends in an xy plane intersecting with the z-direction, for example. The insulation sheet 40 surrounds the periphery of the laminated body 10, for example. The insulation sheet 40 may be, for example, a single insulating film, and a plurality of insulating films may be stacked. When the insulation sheet 40 is composed of a plurality of insulating films stacked, sides are fixed by, for example, tape. In FIG. 2, the thickness of the insulation sheet 40 is indicated by T40, and in FIGS. 2 and 3, the width of the insulation sheet 40 in the x-direction is indicated by W40 and the length thereof in the y-direction is indicated by L40. The thickness T40 of the insulation sheet 40 is, for example, 50 to 250 μm, preferably 90 to 210 μm, and more preferably 95 to 160 μm.

The insulation sheet 40 is, for example, an insulating resin, and a well-known insulating material can be used. The insulation sheet 40 is preferably an insulating film that is easy to process. The insulation sheet 40 is composed of, for example, polyethylene terephthalate, polypropylene, polyimide, and PTFE.

The insulation sheet 40 has therein a through-hole H40 penetrating in the z-direction, for example. The laminated body 10 is housed in the through-hole H40, for example.

The shape of the through-hole H40 when viewed in a plan view in the z-direction is, for example, similar to the laminated body 10. Hereinafter, a case where the shapes of the through-hole H40 and the laminated body 10 are circular will be described as an example.

The through-hole H40 when viewed in a plan view in the z-direction is larger than the laminated body 10. In other words, an inner dimension d40 of the through-hole H40 when viewed in a plan view in the z-direction is larger than an outer dimension D10 of the laminated body 10. Therefore, the insulation sheet 40 and the laminated body 10 are placed apart from each other, and there is a space R between the insulation sheet 40 and the laminated body 10. Although FIG. 3 shows a case where the distance between the insulation sheet 40 and the laminated body 10 is constant at any position, the distance between the insulation sheet 40 and the laminated body 10 may vary depending on the location.

### (Adhesive Sheet)

The adhesive sheet 50A has the first adhesive sheet 51A and the second adhesive sheet 52A as described above. The first adhesive sheet 51A is positioned between the insulation sheet 40A and the positive electrode current collector 15A and is bonded to at least a part of the insulation sheet 40A and the positive electrode current collector 15A. The first adhesive sheet 51A makes a main surface S40A of the insulation sheet 40A adhere to a main surface S15A of the positive electrode current collector 15A, for example. The second adhesive sheet 52A is positioned between the insulation sheet 40A and the negative electrode current collector 15B and is bonded to at least a part of the insulation sheet 40A and the negative electrode current collector 15B. The second adhesive sheet 52B bonds a main surface S40B of the insulation sheet 40 to a main surface S15B of the negative electrode current collector 15B.

The adhesive sheet 50A is provided along an end surface of the insulation sheet 40A on a side close to the laminated body 10. In the present embodiment, the configuration described as a feature of the adhesive sheet 50A is a common feature of the first adhesive sheet 51A and the second adhesive sheet 52A.

The adhesive sheet 50A is, for example, double-sided tape, an adhesive, and a thermal adhesive sheet.

Specific examples of double-sided tape include double-sided tape of which an adhesive layer is made of any of rubber-based, acrylic-based, or silicone-based materials and a base material is made of any materials such as a non-woven fabric, a film, a foamed body, a cloth, and Japanese paper, and double-sided tape composed of only the adhesive layer with no base material. Specific examples of adhesives include adhesives based on vinyl resin, styrene resin, rubber, and ethylene resin. Specific examples of thermal adhesive sheets include an epoxy resin-based thermal adhesive sheet such as FB-ML80/FB-ML4 (manufactured by Nitto Denko Corporation).

The placement and shape of the adhesive sheet 50A correspond to the placement and shape of the current collector 15 and the laminated body 10, for example. The adhesive sheet 50A is provided with, for example, a through-hole H50 for housing the laminated body 10. The adhesive sheet 50A surrounds the substantially entire circumference of the laminated body 10 by the through-hole H50, for example. The first adhesive sheet 51A is apart from the laminated body 10 and surrounds the entire circumference of the laminated body 10, for example. The second adhesive sheet 52A has, for example, at least one void A formed, and the laminated body 10 and the exterior body 20 are communicating with respect to each other through the void A. In other words, the void A plays a role of an exhaust path for exhausting a gas in the vicinity of the laminated body 10 to an area apart from the laminated body 10. The void A when viewed in a plan view in the lamination direction is, for example, linear and is provided to connect the end surfaces of the through-hole H50 and the second adhesive sheet 52A.

The width of the void A formed in the second adhesive sheet 52A is preferably smaller than the width of the laminated body 10 when viewed in a plan view in the z-direction and more preferably smaller than the minimum width of the laminated body 10. The width of the void A of the second adhesive sheet 52A is a length in the direction orthogonal to the longitudinal direction of the void A and is a width of the void A in the x-direction of the example shown in FIG. 3. When the width of the void A of the second adhesive sheet 52A is smaller than the width of the laminated body 10 when viewed in a plan view in the z-direction, an effect of inhibiting the positional displacement of the laminated body 10 in the in-plane direction is likely to be obtained. In the all-solid-state battery 100A, the shape of the void A when viewed in the y-direction is defined, for example, by the positive electrode current collector 15A, the second adhesive sheet 52A, and the insulation sheet 40.

The formation of the void A with respect to the second adhesive sheet 52A can be formed together with the through-hole H50 through punching processing using a mold, for example. The shape of the inner circumference of the insulation sheet 40 on a side close to the laminated body 10 when viewed in the lamination direction may be similar to or congruent with the shape of the inner circumference of either the first adhesive sheet 51A or the second adhesive sheet 52A on a side close to the laminated body 10.

In addition, the dimensions of the inner circumference of the first adhesive sheet 51A and the second adhesive sheet 52A surrounding the laminated body 10 when viewed in the lamination direction may be less than or equal to the dimensions of the insulation sheet 40 surrounding the laminated body 10. In other words, the inner dimension d40 may be less than or equal to an inner dimension d50.

The thickness of the first adhesive sheet 51A is T51, and the thickness of the second adhesive sheet 52A is T52. Hereinafter, the thicknesses T51 and T52 are not particularly distinguished, they are simply referred to as a thickness T50 of the adhesive sheet 50A. The thickness T50 of the adhesive sheet 50A in the lamination direction is, for example, 1 to 150 μm, preferably 4 to 110 μm, and more preferably 20 to 105 μm. The ratio T51/T52 of the thickness T51 of the first adhesive sheet 51A to the thickness T52 of the second adhesive sheet 52A is, for example, 0.1 to 10, preferably 0.15 to 7, and more preferably 0.9 to 3.

In the superimposed region where the adhesive sheet 50A and the insulation sheet 40 overlap, the total thickness of all the adhesive sheet 50A and the insulation sheet 40 is indicated as a thickness T45. The ratio T45/T10 of the total thickness T45 of the adhesive sheet 50A and the insulation sheet 40 to the thickness T10 of the laminated body 10 is, for example, 20% to 100%, preferably 50% to 100%, and more preferably 65% to 95%. That is, the thickness T10 of the laminated body 10 is preferably larger than the thickness T45 of the insulation unit 45. By such a configuration, the adhesion of the positive electrode current collector 15A and the positive electrode active material layer 11 and the adhesion of the negative electrode current collector 15B and the negative electrode active material layer 13 can be increased. In addition, the ratio T40/T45 of the thickness T40 of the insulation sheet 40 to the thickness T45 of the insulation unit, which is the total thickness of the insulation sheet 40, the first adhesive sheet 51A, and the second adhesive sheet 52A is, for example, 0.2 to 1.2, preferably 0.3 to 0.96, and more preferably 0.31 to 0.7.

The space between the positive electrode current collector 15A and the negative electrode current collector 15B depends on the thickness of a structure sandwiched therebetween, for example. For example, a region in which the laminated body 10, the positive electrode current collector 15A, and the negative electrode current collector 15B overlap in the z-direction is referred to as a first region, and a region in which the adhesive sheet 50A and the insulation sheet 40 overlap in the z-direction is referred to as a second region. In this case, the space between the positive electrode current collector 15A and the negative electrode current collector 15B in the first region (hereinafter referred to as a first space) is wider than the space between the positive electrode current collector 15A and the negative electrode current collector 15B in the second region (hereinafter referred to as a second space). The ratio of the second space to the first space is the same as the ratio T45/T10 of the total thickness T45 of the layered insulation unit 45 in the second region to the thickness T10 of the laminated body 10.

In addition, for example, when the total thickness T45 in the second region is smaller than the thickness T10 of the laminated body 10, the second space is configured to be smaller than the first space. In such a configuration, for example, the positive electrode current collector 15A and the negative electrode current collector 15B in the first region are configured to be recessed by the laminated body 10. Accordingly, when the total thickness T45 of the adhesive sheet 50A and the insulation sheet 40 is within the range with respect to the thickness of the laminated body 10, the laminated body 10 is likely to adhere to the current collector 15, likely to lower the internal resistance, and likely to inhibit chipping of the laminated body.

The distance between the adhesive sheet 50A and the laminated body 10 in the in-plane direction may differ depending on the positions in the z-direction. In this case, the shortest distance between the adhesive sheet 50A and the laminated body 10 in the in the in-plane direction is referred to as a distance da. The distance da between the inner dimension d50 and the outer dimension D10 is, for example, 0 mm to 1 mm, and may be 0.1 mm to 1 mm or 0.5 mm to 1 mm. The ratio D10/d50 of the inner dimension d50 of the through-hole H50 to the outer dimension D10 of the laminated body 10 is, for example, 0.9 to 1, and may be 0.9 to 0.97. In this manner, the positional displacement of the laminated body 10 is likely to be inhibited by making the inner dimension d50 of the adhesive sheet 50A correspond to the outer dimension D10 of the laminated body 10.

Next, an example of a method for manufacturing the all-solid-state battery according to the present embodiment will be described. The all-solid-state battery according to the present embodiment is manufactured through a powder molding method.

### (Step of Forming Laminated Body)

First, a resin holder having 51 in the center, a lower punch, and an upper punch were prepared. A metal holder made of die steel may be used instead of the resin holder to improve moldability. The diameter of the through-hole of the resin holder can be a desired size as the outer dimension D10 of the laminated body 10 and large enough to insert the above-described lower punch and upper punch. The lower punch is inserted from below the through-hole of the resin holder, and a powdery solid electrolyte is placed from the opening side of the resin holder. Next, the upper punch is inserted from above the placed powdery solid electrolyte, placed on a press, and pressed to form a solid electrolyte layer 12.

Next, the upper punch is once removed, and the material for a positive electrode active material layer is placed on the upper punch of the solid electrolyte layer 12. Thereafter, the upper punch is inserted thereinto again and pressed to form a positive electrode active material layer 11.

Next, the lower punch is once removed, and the material for a negative electrode active material layer is placed on the lower punch of the solid electrolyte layer 12. For example, the material for negative electrode active material layer is placed on the solid electrolyte layer 12 so that the sample is turned upside down and faces the positive electrode active material layer 11. Thereafter, the lower punch is inserted thereinto again and pressed. Thereafter, as a main molding, pressing is performed at a higher pressure than that of the previous pressing, for example. By doing this, a laminated body in which the positive electrode active material layer 11, the solid electrolyte layer 12, and a negative electrode active material layer 13 are laminated in this order is formed.

Next, the laminated body 10 is removed from the resin holder. To remove the laminated body 10 from the resin holder, for example, the upper punch is inserted and pressed in a state where the lower punch is removed. In addition, the lower punch is inserted and pressed in a state where the upper punch is removed. The laminated body 10 is obtained in this manner.

### (Step of Forming Insulation Unit)

First, an insulating film having a predetermined external shape is first prepared. Next, the insulating film is pressed with a molding die and cut. The mold die has a shape corresponding to a desired through-hole H40. The molding die is installed at a desired position for forming a through-hole H40 in the insulating film. A punching blade is used to cut the insulating film. A Pinnacle blade (Pinnacle is a registered trademark) or the like can be used as the punching blade.

Next, double-sided tape for an adhesive sheet is prepared. The double-sided tape is cut to form a through-hole H50 and a void A. The cutting of an adhesive sheet may be carried out, for example, through punching processing in the same manner as in the means for forming the through-hole H40 in the insulation sheet, and may be carried out using cutting means such as scissors. In this manner, a layered insulation unit 45 in which a first adhesive sheet 51A and a second adhesive sheet 52A are respectively provided on main surfaces S40A and S40B of an insulation sheet 40 is obtained.

### (Step of Forming Positive Electrode Current Collector and Negative Electrode Current Collector)

A positive electrode current collector 15A and a negative electrode current collector 15B are obtained by punching a current collector material into a desired shape using, for example, a punching blade. For example, a Pinnacle blade (Pinnacle is a registered trademark) or the like can be used as the punching blade.

### (Assembly)

First, leads 16 and 14 which are tab leads are respectively attached to the outside of the positive electrode current collector 15A and the negative electrode current collector 15B in the lamination direction. The leads 16 and 14 can be respectively joined to the positive electrode current collector 15A and the negative electrode current collector 15B through, for example, ultrasonic welding.

Next, the insulation sheet 40 is bonded to either the positive electrode current collector 15A or the negative electrode current collector 15B through the adhesive sheet 50A. Hereinafter, an example of bonding the insulation sheet 40 to the positive electrode current collector 15A through the adhesive sheet 50A will be described, but the insulation sheet 40 may be bonded to the negative electrode current collector 15B.

Next, the laminated body is housed in the through-holes H40 and H50 of the layered insulation unit 45 using forceps or the like.

Next, the insulation sheet 40 is bonded to the negative electrode current collector 15B through the second adhesive sheet 52B so that the laminated body 10 and the layered insulation unit 45 are sandwiched between the positive electrode current collector 15A and the negative electrode current collector 15B.

Next, opening portions of an exterior body 20 are heat-sealed except for one opening portion. Thereafter, the remaining opening portion may be heat-sealed while evacuating the interior of the exterior body 20. By performing heat-sealing while evacuating, the exterior body 20 can be sealed in a state in which the amount of gas and moisture present in the housing space K is small.

The all-solid-state battery 100A of the present embodiment is obtained through the above-described steps.

Although an example of manufacturing the all-solid-state battery 100A utilizing double-sided tape as an adhesive sheet has been described above, the present invention is not limited to this example. For example, in the method for manufacturing the all-solid-state battery according to the present embodiment, an adhesive or a thermal adhesive sheet may be used instead of the double-sided tape as an adhesive sheet material. When an adhesive is used as an adhesive sheet material, the adhesive may be provided so as to overlap the main surface of the insulation sheet 40 immediately before bonding the insulation sheet 40 to the current collector 15, for example. When a thermal adhesive sheet is used as an adhesive sheet material, for example, it is sufficient as long as a volatile resin by heating is formed in a region forming the void A, the thermal adhesive sheet is formed on the other region of the insulation sheet, and heating is performed in a state where the insulation sheet 40 and the adhesive sheet 50A, which house the laminated body 10 in the through-holes H40 and H50, are sandwiched between the positive electrode current collector 15A and the negative electrode current collector 15B. By doing this, the main surface of the current collector 15 can be bonded to the main surface of the insulation sheet 40 through the adhesive sheet 50A to form an electrical storage element 90 in which the laminated body 10 and the exterior body 20 are communicating with respect to each other. In addition, although the example of providing the adhesive sheet material on the insulation sheet 40 to perform punching processing has been described, but not limited to this example, the adhesive sheet 50A and the insulation sheet 40 may be separately subjected to punching processing and then stacked. In addition, the example of attaching the leads 14 and 16 to the outside of the positive electrode current collector 15A and the negative electrode current collector 15B in the lamination direction has been shown, but not limited to this example, the leads 14 and 16 may be attached to the inside of the positive electrode current collector 15A and the negative electrode current collector 15B in the lamination direction.

The all-solid-state battery 100A according to the present embodiment has the first adhesive sheet 51A and the second adhesive sheet 52A respectively between the insulation sheet 40 and the positive electrode current collector 15A and between the insulation sheet 40 and the negative electrode current collector 15B, and the laminated body 10 and the exterior body 20 are communicating with respect to each other. Therefore, it is possible to inhibit gases such as atmospheric air and water vapor from being sealed by the insulation unit 45, the positive electrode current collector 15A, and the negative electrode current collector 15B together with the laminated body 10 during assembly. In addition, even if a solid electrolyte in the laminated body 10 reacts with water or a gas such as hydrogen chloride is generated, because the laminated body 10 communicates with the exterior body 20, it is possible to suppress deterioration of the adhesion between the laminated body 10 and the positive electrode current collector 15A and between the laminated body 10 and the negative electrode current collector 15B due to an increase in atmospheric pressure caused in the sealed space in which the laminated body 10, the positive electrode current collector 15A, and the negative electrode current collector 15B constitute a part of the contour. Accordingly, according to the all-solid-state battery 100A of the present embodiment, it is possible to suppress an increase in the internal resistance between the laminated body 10 and the current collector 15. In the all-solid-state battery 100A, the insulation sheet 40 can be bonded to the current collector 15 using the adhesive sheet 50A, and the decrease in the adhesion between the insulation sheet 40 and the current collector due to the above-described increase in atmospheric pressure is avoided. Therefore, it is possible to suppress the above-described increase in the internal resistance without using a restraint to pressurize in the lamination direction. When the internal resistance of the all-solid-state battery increases excessively, for example, the laminated body 10 and the current collector 15 are peeled off from each other, the battery capacity may decrease. However, in the all-solid-state battery 100A according to the present embodiment, the decrease in the battery capacity can be suppressed.

In addition, in the all-solid-state battery 100A, the insulation unit 45 is provided so as to surround the laminated body 10 in the in-plane direction, and the width of the void A in the short-side direction is smaller than the diameter of the laminated body 10. Therefore, the positional displacement of the laminated body 10 in the in-plane direction is likely to be particularly inhibited. Therefore, contact of the laminated body 10 with the positive electrode current collector 15A and the negative electrode current collector 15B on the inner side than the through-holes H40 and H50 is likely to be inhibited.

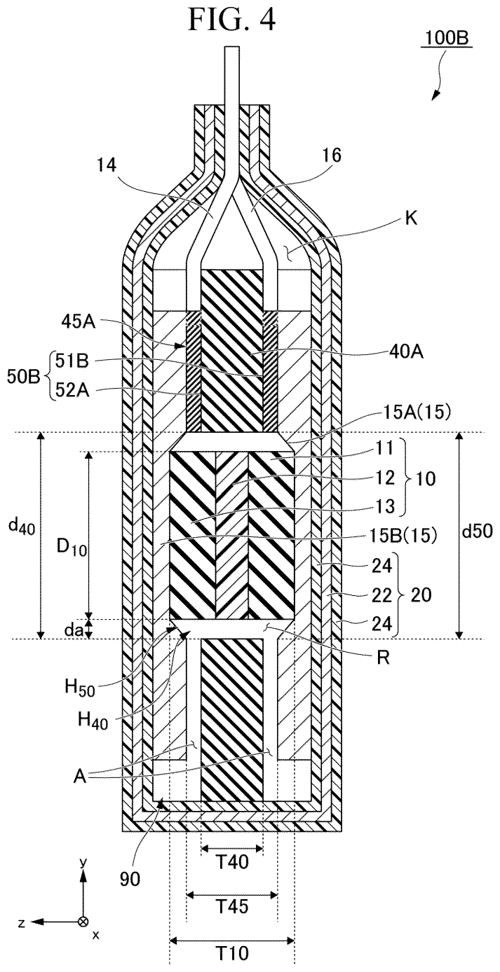

Although the embodiments of the present invention have been described in detail above, the present invention is not limited to the above-described embodiments and various modifications and changes can be made within the scope of the gist of the present invention disclosed in the claims. For example, although the configuration in which a void is formed in the second adhesive sheet 52A has been exemplified in FIGS. 1 to 3, it is sufficient as long as a void is formed either the first adhesive sheet 51A or the second adhesive sheet 52A, and a configuration in which a void is formed in the first adhesive sheet 51A without forming a void in the second adhesive sheet 52A may be employed. In addition, for example, the all-solid-state battery according to the embodiments of the present invention may be all-solid-state batteries as shown in FIGS. 4 to 16. In FIGS. 4 to 16, the same configurations as in the all-solid-state battery 100A shown in FIGS. 1 to 3 are given the same reference numerals, and description thereof will not be repeated.

FIG. 4 is a cross-sectional view of an all-solid-state battery according to one embodiment of the present invention which is cut along the lamination direction. An all-solid-state battery 100B shown in FIG. 4 differs from the all-solid-state battery 100A in that a void is also formed in the first adhesive sheet 51A. A first adhesive sheet 51B and a second adhesive sheet 52A in the all-solid-state battery 100B are provided with voids of the same shape at overlapping positions when viewed in a plan view in the z-direction, for example.

Since voids A in which a laminated body 10 and an exterior body 20 are communicating with respect to each other are formed in both the first adhesive sheet 51B and the second adhesive sheet 52A, hydrogen chloride or hydrogen sulfide in the vicinity of either a positive electrode active material layer 11 or a negative electrode active material layer 13 can be exhausted through the voids A.

Although the example in which the voids A formed in the first adhesive sheet 51A and the second adhesive sheet 52A are positioned at overlapping regions when viewed in a plan view in the z-direction has been shown, the two voids A may be provided at non-overlapping positions when viewed in a plan view in the z-direction. For example, they may be provided at positions facing each other in the in-plane direction of the laminated body 10. When the two voids A are provided at non-overlapping positions in the in-plane direction, a gas generated in a space R is preferentially exhausted from a void on a side close to the in-plane direction between the two voids A, which is thought to allow the exhaustion of the gas to proceed faster. In other words, the gas is difficult to accumulate in the space R because of the plurality of voids A. In addition, when pasting the laminated body 10 to a positive electrode current collector 15A and pasting the laminated body 10 to the negative electrode current collector 15B during a manufacturing process thereof, the positive electrode current collector 15A and the negative electrode current collector 15B are less likely to be wrinkled.

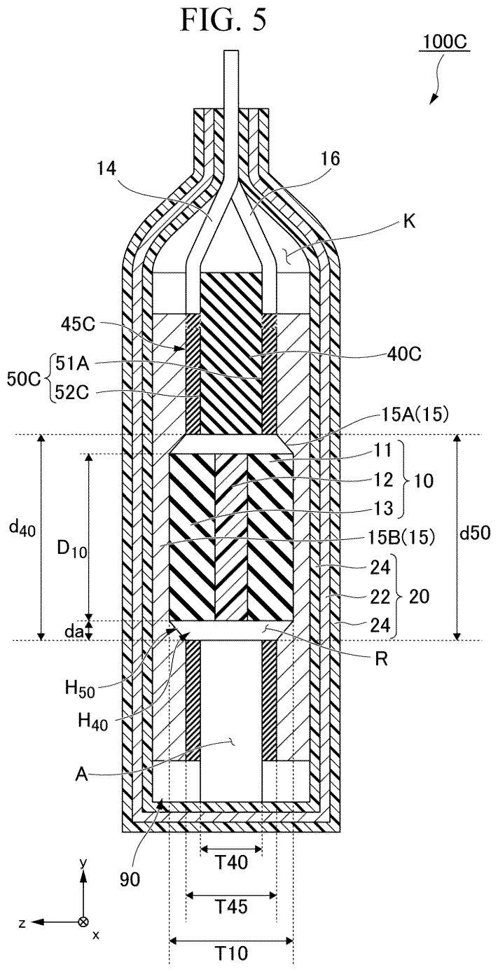

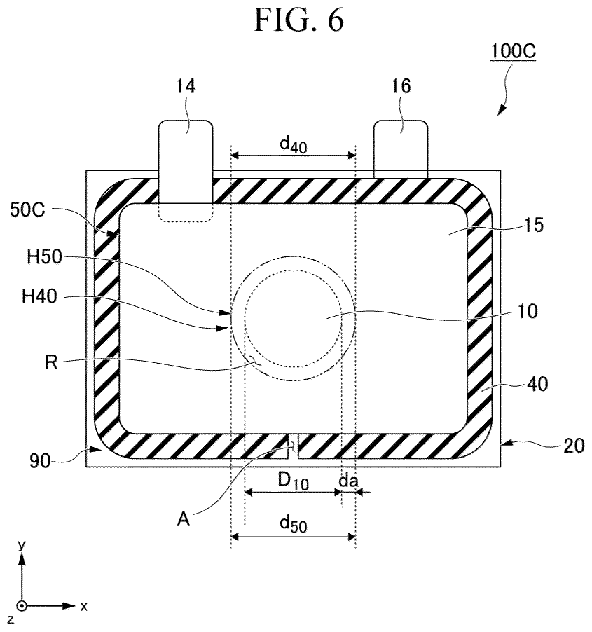

FIG. 5 is a cross-sectional view of an all-solid-state battery according to another embodiment of the present invention which is cut along the lamination direction, and FIG. 6 is a plan view of the all-solid-state battery of FIG. 5 when viewed in the z-direction. An all-solid-state battery 100C shown in FIGS. 5 and 6 differ from the all-solid-state battery 100A in that a void A is provided only in an insulation sheet 40C in an insulation unit 45C. In other words, in the all-solid-state battery 100C, no void is provided in a second adhesive sheet 52C. The void A provided in the insulation sheet 40C allows communication between a laminated body 10 and an exterior body 20. The width of the void A provided in the insulation sheet 40C is the same as the width of the void A provided in the second adhesive sheet 52A in the all-solid-state battery 100A, for example. In the all-solid-state battery 100C, the formation of the void A for the insulation sheet 40C can be performed by the same means as, for example, formation of a through-hole H40 for the insulation sheet 40C.

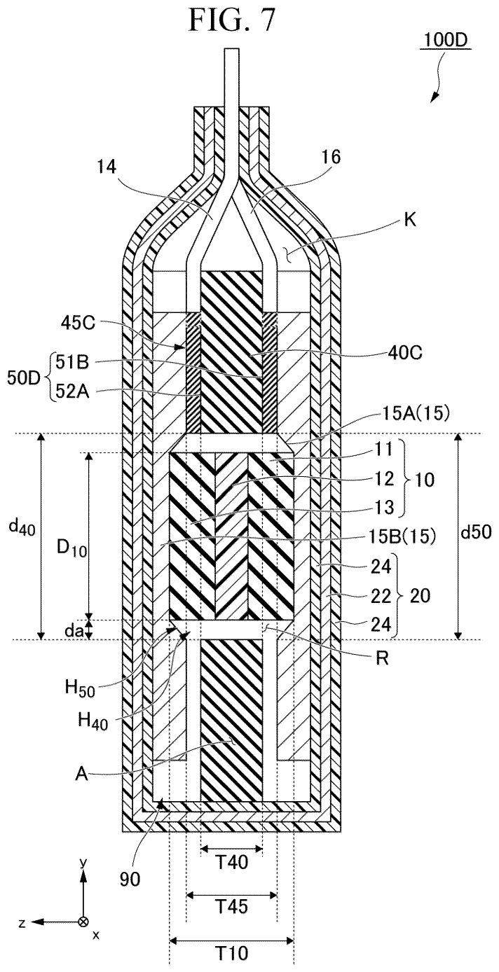

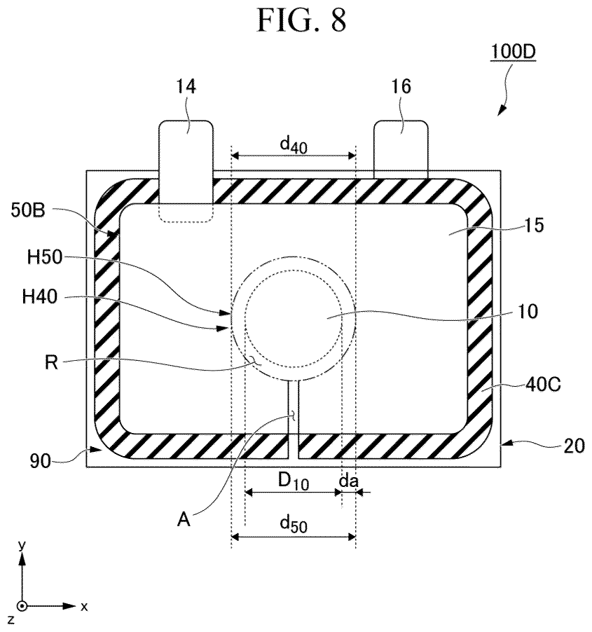

FIG. 7 is a cross-sectional view of an all-solid-state battery according to still another embodiment of the present invention which is cut along the lamination direction, and FIG. 8 is a plan view of the all-solid-state battery of FIG. 7 when viewed in the lamination direction. In all-solid-state battery 100D shown in FIGS. 7 and 8, voids A are provided in a first adhesive sheet 51B, a second adhesive sheet 52A, and an insulation sheet 40C at overlapping positions when viewed in a plan view in the z-direction. As shown in FIGS. 7 and 8, the all-solid-state battery may be provided with the voids A in any of the adhesive sheet and the insulation sheet. When the voids A are formed in any of the insulation sheet 40C, the first adhesive sheet 51B, and the second adhesive sheet 52A and provided at overlapping positions when viewed in a plan view in the lamination direction as shown in the all-solid-state battery 100D, it is preferable to form the voids through batch punching after overlaying the adhesive sheets on the insulating film from the viewpoint of improving manufacturing throughput. In the all-solid-state battery 100D, the voids A when viewed in a plan view in the y-direction are defined by a positive electrode current collector 15A, the first adhesive sheet 51B, the insulation sheet 40C, the second adhesive sheet 52A, and a negative electrode current collector 15B.

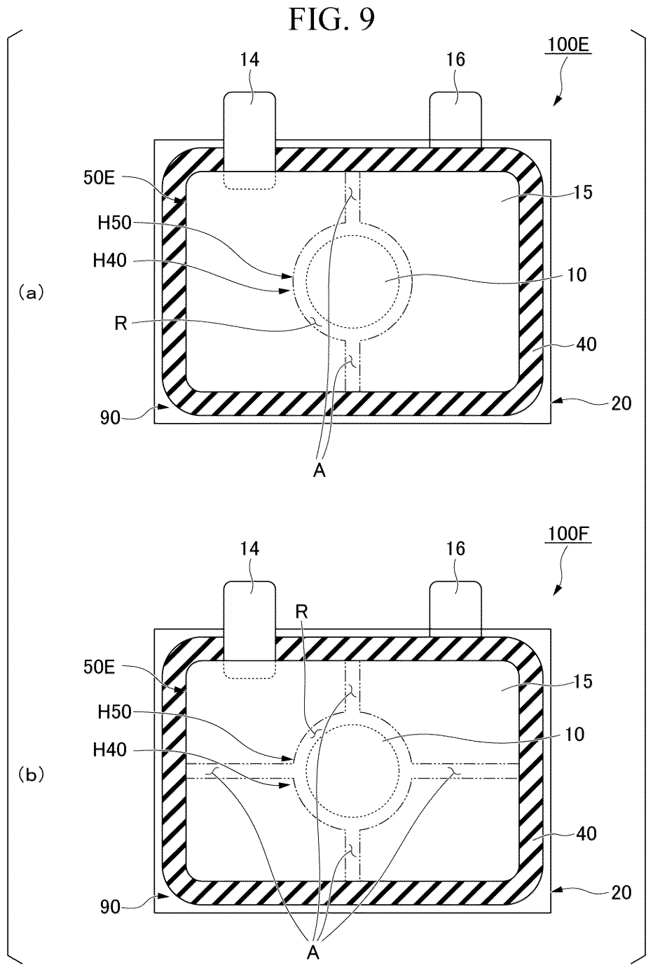

FIG. 9 shows plan views of all-solid-state batteries according to modification examples of FIG. 3 when viewed in the z-direction. In an all-solid-state battery 100E shown in FIG. 9(a), two voids A are formed in at least one of a first adhesive sheet, an insulation sheet, and a second adhesive sheet and are provided at non-overlapping positions when viewed in a plan view in the z-direction. In an all-solid-state battery 100F shown in FIG. 9(b), four voids A are formed in at least one of a first adhesive sheet, an insulation sheet, and a second adhesive sheet and are provided at non-overlapping positions when viewed in a plan view in the lamination direction.

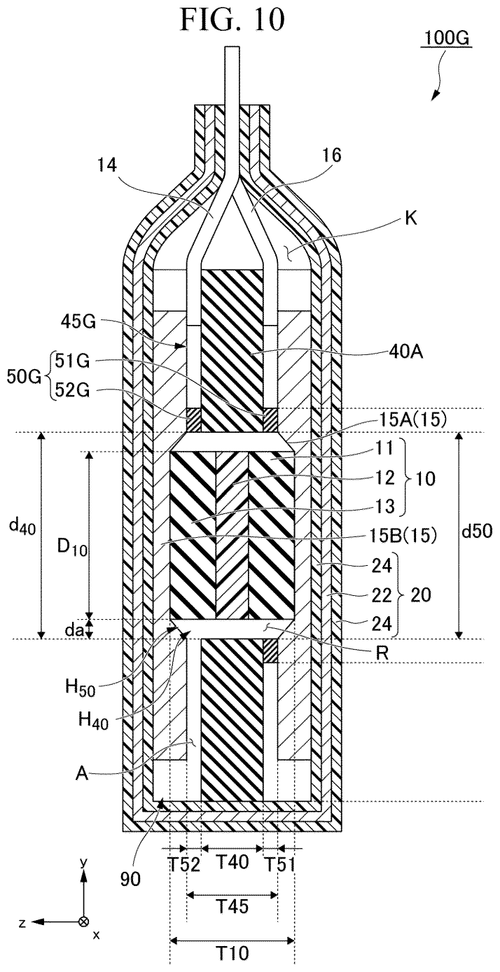

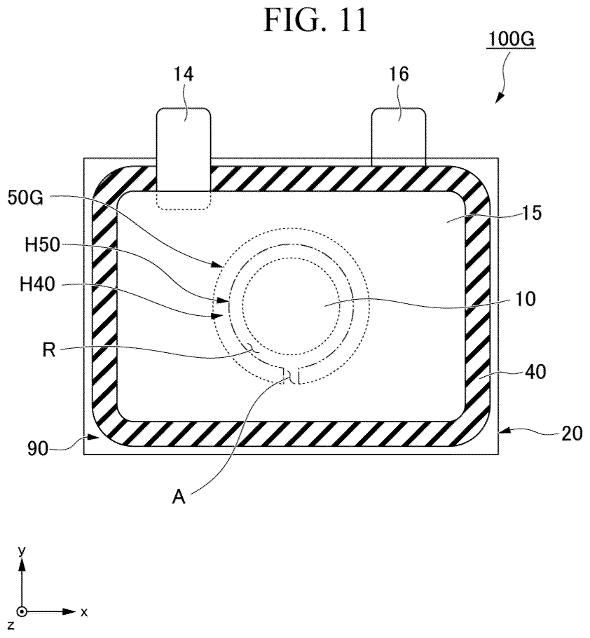

FIG. 10 is a cross-sectional view of an all-solid-state battery according to still another embodiment of the present invention which is cut along the lamination direction, and FIG. 11 is a plan view of the all-solid-state battery of FIG. 10 when viewed in the lamination direction. In the all-solid-state battery shown in FIGS. 10 and 11, an adhesive sheet 50G is provided along an end surface of an insulation sheet 40A on a side close to the laminated body 10.

A first adhesive sheet 51G is, for example, an annular adhesive sheet having an inner diameter larger than the outer diameter of the laminated body 10. A second adhesive sheet 52G has a shape in which a part is removed from the first adhesive sheet 51G, for example. The second adhesive sheet 52G has a shape in which a part thereof is removed from an annular shape, for example. The second adhesive sheet 52G has a “C”-shape. In addition, it may have a shape in which a part is removed from a polygonal shape.

By providing the adhesive sheet 50G along the end surface of the insulation sheet 40A on a side close to the laminated body 10 as in the all-solid-state battery 100G, the positional displacement of the laminated body 10 in the in-plane direction can be inhibited. In addition, since the vicinity of the laminated body 10 is fixed in the in-plane direction, poor contact between the laminated body 10 and the current collector 15 is likely to be inhibited, and an effect of suppressing an increase in internal resistance and a decrease in battery capacity is likely to be obtained.

FIG. 12 is a cross-sectional view of an all-solid-state battery according to still another embodiment of the present invention which is cut along the lamination direction, and FIG. 13 is a plan view of the all-solid-state battery of FIG. 12 when viewed in the lamination direction. An all-solid-state battery 100H shown in FIGS. 12 and 13 differs from the all-solid-state battery 100A in the shape of a laminated body 10H and the shape and arrangement of an insulation sheet 40H and an adhesive sheet 50H. The shape of the laminated body 10 may be substantially quadrangular as shown in FIG. 13.

In the all-solid-state battery 100H, the insulation sheet 40H has a through-hole H40 having a shape similar to the laminated body 10H, for example. The insulation sheet 40H may be provided apart from the laminated body 10 in the in-plane direction compared to the insulation sheet 40A. The insulation sheet 40H is provided so as to overlap the entire contour of a current collector 15 when viewed in a plan view in the z-direction, for example. The adhesive sheet 50H is provided so that a part of it overlaps the current collector and a part of it does not overlap the current collector 15 when viewed in a plan view in the z-direction, for example. The adhesive sheet 50H is provided only in the −y-direction with respect to the laminated body 10H, for example. Therefore, the laminated body 10H is, for example, a region between the insulation sheet 40H and the current collector 15 in the z-direction and is communicating with respect to the exterior body 20 in the ±x-direction and the +y-direction with respect to the laminated body 10H.

The adhesive sheet 50H provided as in the all-solid-state battery 100H is positioned in a first direction with respect to the laminated body 10H, and an end portion of the insulation sheet 40H at the inner circumference is bonded to the current collector 15. In this manner, the all-solid-state battery may have a configuration in which a part of the inner peripheral end of the insulation sheet is bonded to the current collector. Even in such a configuration, the laminated body 10H and the exterior body 20 are communicating with respect to each other, a sudden increase in atmospheric pressure in the vicinity of the laminated body 10 in the exterior body 20 can be suppressed, and a decrease in the internal resistance can be suppressed.

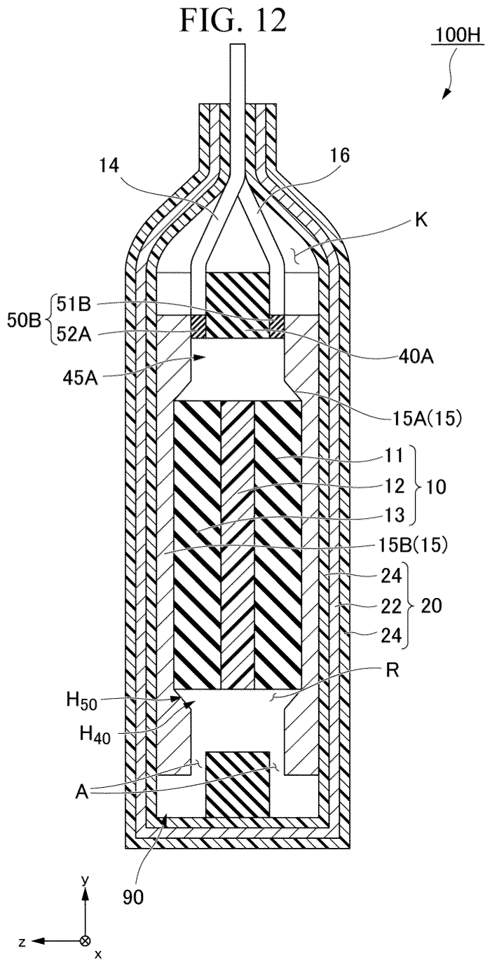

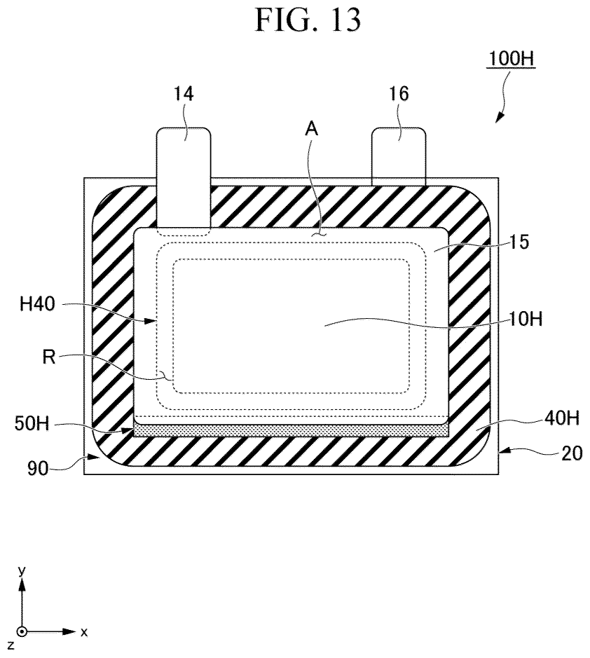

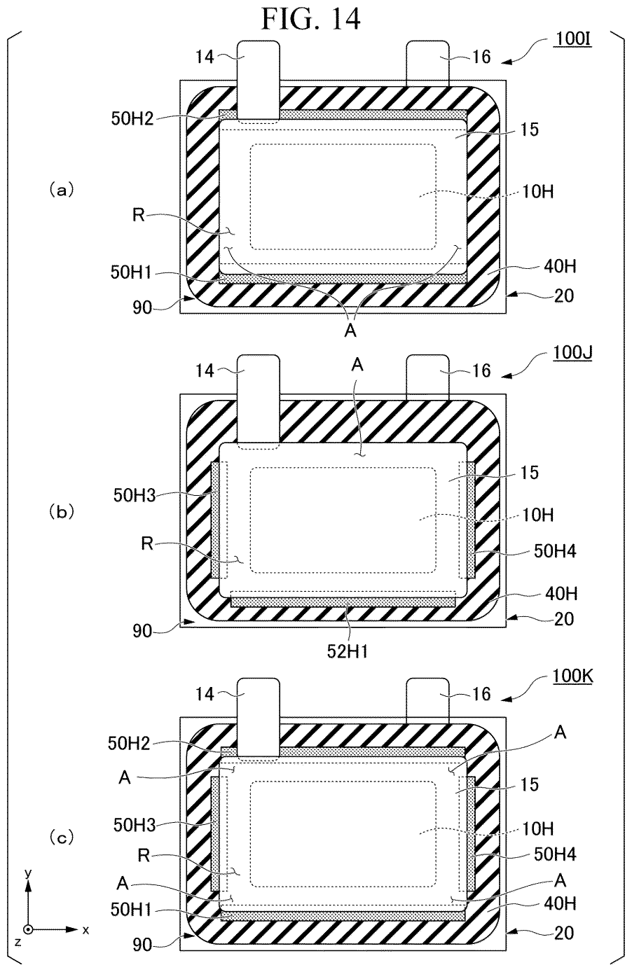

In addition, the all-solid-state battery may have configurations as shown in FIG. 14. All-solid-state batteries 100I, 100J, and 100K shown in FIGS. 14(a), 14(b), and 14(c) differ from the all-solid-state battery 100H in the number of adhesive sheets 50H. In the all-solid-state batteries 100I, 100J, and 100K, a first adhesive sheet and a second adhesive sheet each include a plurality of adhesive sheets provided apart from each other in different orientations with respect to a laminated body 10H, for example.

The all-solid-state battery 100I further includes an adhesive sheet 50H2 positioned in the +y-direction with respect to the laminated body 10H, the all-solid-state battery 100I further includes adhesive sheets 50H3 and 50H4 positioned in the +x-direction with respect to the laminated body 10H, and the all-solid-state battery 100K further includes an adhesive sheet 50H2 positioned in the +y-direction with respect to the laminated body 10H and adhesive sheets 50H3 and 50H4 positioned in the ±x-direction with respect to the laminated body 10H. In addition, in the all-solid-state batteries 100I, 100J, and 100K, the adhesive sheets 50H1, 50H2, 50H3, and 50H4 are shorter than the side length of a current collector 15 that overlaps with the adhesive sheets when viewed in a plan view in the lamination direction, for example. Even in the all-solid-state batteries 100I, 100J, and 100K as shown in FIG. 14, voids are formed at least between the adhesive sheets, and therefore, exhaust paths for a gas can be secured and an increase in the internal resistance can be suppressed. As long as voids A are generated, the length of the adhesive sheets 50H1 to 50H4 may be longer than the side length of the current collector 15.

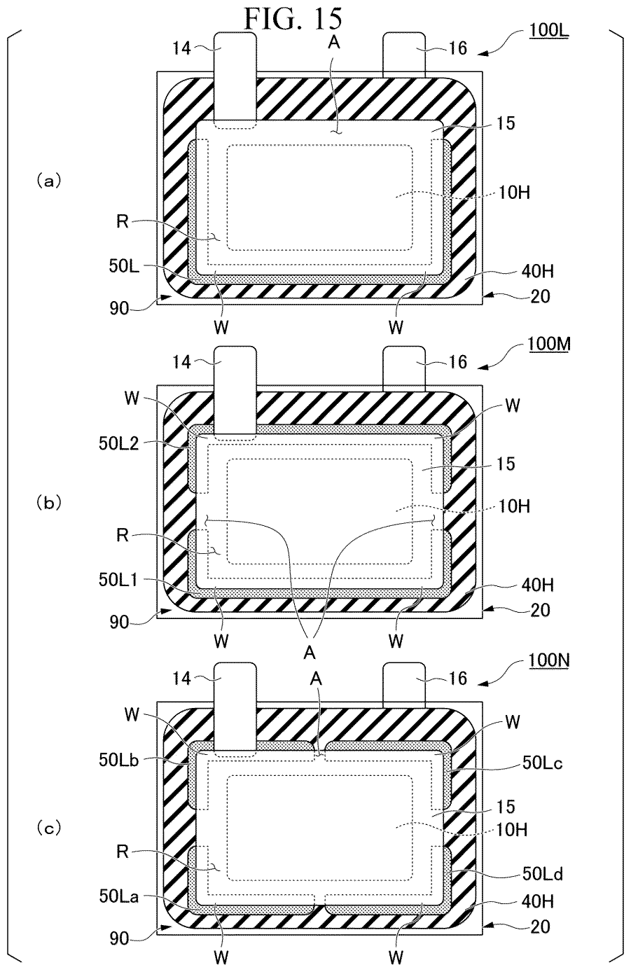

In addition, all-solid-state batteries may have configurations as shown in FIG. 15. All-solid-state batteries 100L, 100M, and 100N shown in (a), (b), and (c) of FIG. 15 differ from the above-described all-solid-state batteries in the shape of adhesive sheets. Adhesive sheets 50L, 50L1, 50L2, 50La, 50Lb, 50Lc, and 50Ld in the all-solid-state batteries 100L, 100M, and 100N each have a curved portion w on end surfaces on sides close to a laminated body 10H. The curved portion w is provided so as to be parallel to near the apex of the laminated body 10H, for example. When a plurality of adhesive sheets are provided in each of the all-solid-state batteries 100L, 100M, and 100N, the plurality of adhesive sheets are arranged apart from each other.

In addition, all-solid-state batteries may have configurations as shown in FIG. 16. All-solid-state batteries 100O, 100P, and 100Q shown in (a), (b), and (c) of FIG. 16 differ from the above-described all-solid-state batteries in the shape of insulation sheets. In the all-solid-state battery 100O, an insulation sheet 40O has a U-shape when viewed in a plan view in the z-direction, for example. The insulation sheet 40O overlaps the entire length of three of the four sides constituting a current collector 15 and overlaps a part of one side when viewed in a plan view in the z-direction. The shape of an adhesive sheet 50L is similar to that of the insulation sheet 40O, for example. The adhesive sheet 50L in the all-solid-state battery 100O is congruent with the first adhesive sheet and the second adhesive sheet, for example. The adhesive sheet 50L overlaps three of the four sides constituting the current collector, for example. A laminated body 10H in the all-solid-state battery 100O communicates with an exterior body 20 through a void A in the +y-direction. The all-solid-state battery 100P includes two insulation sheets 40P1 and 40P2 provided apart from each other in the y-direction and adhesive sheets 50L1 and 50L2 that bond the insulation sheets 40P1 and 40P2 to the current collector 15. The insulation sheets 40P1 and 40P2 and the adhesive sheets 50L1 and 50L2 extend in the x-direction and are arranged parallel to each other. In the all-solid-state battery 100P, the laminated body 10H communicates with an exterior body 20 through a voids in the ±x-direction. The all-solid-state battery 100Q includes four insulation sheets 40P1, 40P2, 40Q1, and 40Q2 provided apart from each other in the in-plane direction. The insulation sheets 40P1 and 40P2 are arranged so as to sandwich the insulation sheets 40Q1 and 40Q2 in the y-direction, for example. The insulation sheets 40P1, 40P2, 40Q1, and 40Q2 are arranged so as to overlap respective sides constituting the outer shape of a current collector 15, for example. The all-solid-state battery 100Q further includes adhesive sheets 50L1, 50L2, 50Q1, and 50Q2, for example. The adhesive sheets 50L1, 50L2, 50Q1, and 50Q2 each are provided so as to overlap one side constituting four sides of the current collector 15, for example. As described above, in the all-solid-state batteries 100P and 100Q, a first adhesive sheet and a second adhesive sheet each include, for example, a plurality of adhesive sheets provided apart from each other in different orientations with respect to the laminated body 10H.

Even in the all-solid-state batteries according to the modification examples as shown in FIGS. 4 to 16 above, a decrease in adhesion between a laminated body and a current collector can be suppressed based on the same principle as the all-solid-state battery 100A shown in FIGS. 1 to 3. Accordingly, an increase in the internal resistance can be suppressed without using fastening members.

Although a configuration in which only one laminated body 10 or 10H is provided in one all-solid-state battery has been shown in the above-described examples, a plurality of laminated bodies may be provided in one all-solid-state battery. When a plurality of laminated bodies are provided in an all-solid-state battery, the plurality of laminated bodies are arranged side by side in the in-plane direction, for example. In addition, the plurality of laminated bodies are communicating with respect to the exterior body 20. As the means for communication between the laminated bodies and the exterior body 20, the same means as the above-described examples can be employed. For example, voids A are formed. In addition, a configuration in which the plurality of laminated bodies are communicating with respect to each other may be employed. In addition, the laminated bodies can be molded in arbitrary shapes, not limited to a circular or quadrangular shape. In addition, the shape of a void A when viewed in the lamination direction is not limited to a linear shape, and may be a bent shape. In addition, fixing tape may further be provided so as to perform bonding with the outside of the positive electrode current collector 15A and the negative electrode current collector 15B of the above-described all-solid-state batteries in the lamination direction. In addition, a fastening member for fastening an all-solid-state battery under pressure in the lamination direction may further be provided. As fastening members, metal plates, bolts, and nuts can be used, for example. Specifically, an exterior body of an all-solid-state battery may be sandwiched between metal plates, and four corners of the metal plates may be fastened and restrained with bolts and nuts.

The above-described plurality of embodiments may be implemented in appropriate combination within the scope of the gist of the claims.

### EXAMPLES

Hereinafter, examples of the present invention will be described. The present invention is not limited to the following examples.

### Example 1

As Example 1, an all-solid-state battery as shown in FIG. 9(b) was prepared, and the battery characteristics were evaluated. Specifically, Example 1 was carried out by the following means.

First, a laminated body in which a positive electrode active material layer, a solid electrolyte layer, and a negative electrode active material layer are laminated in this order was prepared through a powder molding method by the following means.

A lower punch with a diameter of 9.99 mm was inserted from below a 10 mm diameter through-hole of a resin holder, the through-hole being in the center of the resin holder. Next, Li₂ZrCl₆, which will become a solid electrolyte layer, was placed from above the through-hole. Next, an upper punch with a diameter of 9.99 mm was inserted from above the through-hole and pressed with a press under a pressure of 5 kN to form a solid electrolyte layer with a thickness of 0.3 mm.

Next, the upper punch was once removed, and a powder obtained by mixing LCO, a solid electrolyte Li₂ZrCl₆, and carbon black in amounts of 0.7 g, 0.35 g, and 0.03 g respectively was used as a positive electrode active material layer. Next, the powder was pressed with the press again under a pressure of 5 kN to form a positive electrode active material layer with a thickness of 0.05 mm on the solid electrolyte layer.

Next, the lower punch was once removed, and an LTO-solid electrolyte mixture which will become a negative electrode active material layer was placed. As the LTO-solid electrolyte mixture, a powder obtained by mixing LTO, Li₂ZrCl₆, and graphite in amounts of 0.55 g, 0.4 g, and 0.05 g respectively using an agate mortar was used. Next, the powder was pressed with the press again under a pressure of 5 kN to form a 0.4 mm thick laminated body in which a 0.05 mm thick negative electrode active material layer was provided on the lower side of the laminated product of the positive electrode active material layer and the solid electrolyte layer.

Next, an insulation sheet and an adhesive sheet were prepared.

Specifically, a 100 μm thick PET sheet Lumirror H10 (manufactured by Toray Industries, Inc.) as an insulation film and two sheets of double-sided tape (product number: HJ-3160W, manufacturer's name: Nitto Denko Corporation) having the same shape (same thickness and plan view shape) as that of the insulation film as adhesive films were prepared.

Next, an insulation sheet was prepared by forming a circular through-hole with an inner diameter of 11 mm in the center of the insulation film in a plan view using Pinnacle blade (Pinnacle is a registered trademark). In addition, a through-hole of the same shape was formed in one of the two sheets of double-sided tape at the same position to form a first adhesive sheet. In addition, a through-hole of the same shape was formed in the other double-sided tape at the same position as that of the above-described through-hole, and holes were formed that pass through the circular center of the through-hole and become voids parallel to sides extending in the longitudinal direction of the double-sided tape and voids extending in the short-side direction to form a second adhesive sheet. In other words, the adhesive sheets were prepared by forming the through-hole positioned in the center of the plan view and the four holes from the center of the four sides to the circular center of the through-hole in the double-sided tape. The above-described insulation sheet was sandwiched between the first adhesive sheet and the second adhesive sheet so that the through-holes overlap to prepare an insulation unit 45 with the adhesive sheets provided on the main surfaces on both sides of the insulation sheet.

Next, an electrical storage element was assembled.

First, leads were respectively joined to a positive electrode current collector and a negative electrode current collector on the outside of the positive electrode current collector and the negative electrode current collector in the lamination direction through ultrasonic welding. As the leads, aluminum sealant tabs were used.

Next, the insulation sheet was bonded to the positive electrode current collector through the first adhesive sheet. Next, the laminated body was placed in the through-hole using forceps. Next, the insulation sheet was bonded to the negative electrode current collector through the second adhesive sheet. By doing this, the laminated body is configured to communicate with outside through the voids defined by the negative electrode current collector, the second adhesive sheet, and the insulation sheet among the electrical storage element.

Next, the obtained electrical storage element was housed in an exterior body. As the exterior body, an aluminum laminate bag was used.

Next, opening portions of the exterior body 20 are heat-sealed except for one opening portion. Thereafter, the remaining opening portion was heat-sealed while evacuating the interior of the exterior body 20. By performing heat-sealing while evacuating, the exterior body 20 can be sealed in a state in which the amount of gas and moisture present in the housing space K is small.

### Comparative Example 1

An all-solid-state battery was prepared as Comparative Example 1 by the same method as in Example 1 except that no holes other than a through-hole were formed in a second adhesive sheet. In other words, in the all-solid-state battery of Comparative Example 1, a laminated body is sealed in a space surrounded by a positive electrode current collector, a first adhesive sheet, an insulation sheet, the second adhesive sheet, and a negative electrode current collector, and the laminated body and an exterior body are not communicating with respect to each other.

### (Battery Capacity Test)

The all-solid-state batteries of Example 1 and Comparative Example 1 were subjected to a battery characteristic test. Specifically, the all-solid-state batteries were allowed to stand in a constant-temperature tank at 25° C., and charging and discharging characteristics were calculated using a charge-discharge system SD8 (manufactured by Hokuto Denko Corporation). First, as a charge test, constant current charging was performed until the battery voltage reached 2.8 V at 0.05 C, then constant current charging was performed until the current density reached 0.01 C, and then constant voltage charging was performed until the current density reached 0.01 C. Thereafter, as a discharge test, constant current discharging was performed until the battery voltage reached 1.3 V at 0.05 C.

### (Internal Resistance)

The internal resistance (AC resistance) after the battery capacity test of the all-solid-state batteries of Example 1 and Comparative Example 1 was measured. The internal resistance was measured using a battery tester BT3563 (manufactured by Hioki E.E. Corporation).

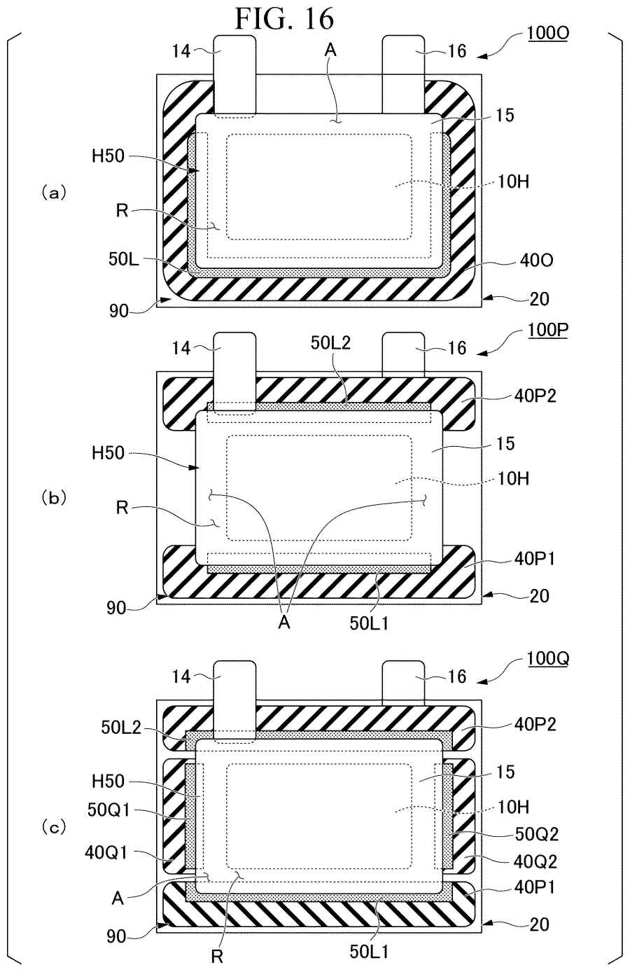

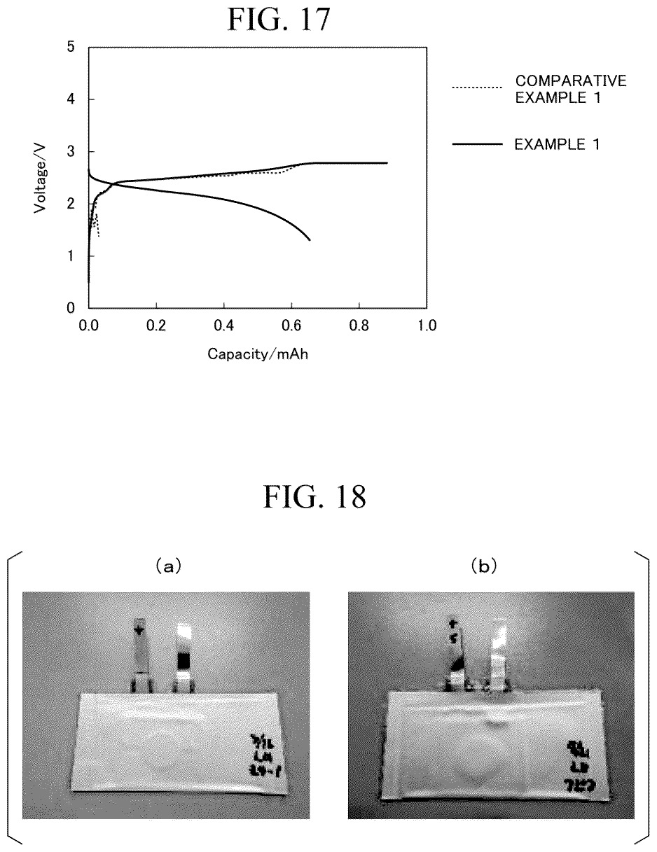

FIG. 17 shows charge-discharge curves of Example 1 and Comparative Example 1, and Table 1 shows the discharge capacity and internal resistance of Example 1 and Comparative Example 1. FIG. 18 is a view showing the state of the all-solid-state batteries after the battery capacity test and the internal resistance test. FIGS. 18(a) and 18(b) show the appearance of the all-solid-state batteries of Example 1 and Comparative Example 1, respectively. In Comparative Example 1, it was confirmed that gas accumulation had occurred in the vicinity of the laminated body which was circular in a plan view and surrounded by the insulation unit. On the other hand, in Example 1, no gas accumulation as occurred in Comparative Example 1 was confirmed.

In Example 1, the discharge capacity was large and the AC resistance was small compared to Comparative Example 1. In Comparative Example 1, it is considered that the adhesion between the laminated body and the current collectors was reduced and the discharge capacity was small as well as the internal resistance was increased because the gas was sealed together with the laminated body during assembly, or because the gas was generated by a reaction of water and the solid electrolyte in the vicinity of the laminated body, as confirmed by the gas accumulation in FIG. 18. In addition, since the charge capacity is large compared to the discharge capacity in Comparative Example 1, it is considered that the effect of the gas generated during the charge (and discharge) process is large compared to the gas sealed together with the laminated body during assembly of the electrical storage element.

In Example 1 above, since the voids were formed so that the laminated body and the exterior body are communicating with respect to each other, an increase in the internal resistance was suppressed and a high discharge capacity was obtained without pressurizing the all-solid-state battery from outside in the laminated direction.

TABLE 1

| | Example 1 | Comparative Example 1 |
|---|---|---|
| Discharge capacity (mAh) | 0.65 | 0.03 |
| Internal resistance (Ω) | 319 | 2128 |

### Example 2

An all-solid-state battery was prepared and the characteristics thereof were evaluated by the same means as in Example 1 except that a fastening member was used to pressurize and fasten the all-solid-state battery in the lamination direction. The pressurization by the fastening member was carried out by applying a force (actual measurement value of 200 kgf) that resulted in a tightening torque of 1 Nm at four corners. Specifically, in Example 2, an exterior body was sandwiched between metal plates via a baking plate, and four corners of the metal plates were fastened and restrained with bolts and nuts. Here, as the metal plates, those having a size larger than that of the exterior body in the in-plane direction can be used.

### Comparative Example 2

An all-solid-state battery was prepared and the characteristics thereof were evaluated by the same means as in Comparative Example 1 except that a fastening member was used to pressurize and fasten the all-solid-state battery in the lamination direction. The fastening of the all-solid-state battery was carried out by the same means as in Example 2.

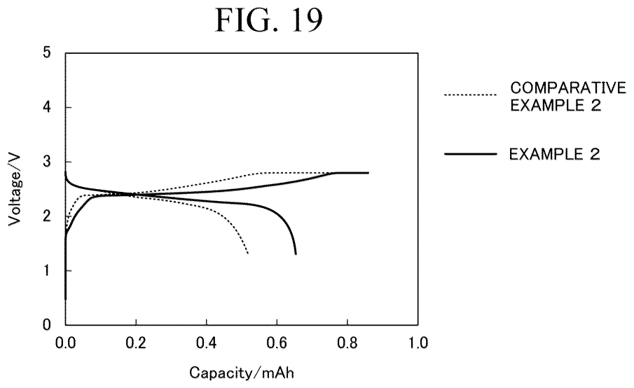

When the fastening member was removed from the all-solid-state battery after measuring the battery characteristics, it was confirmed that gas accumulation had occurred in the vicinity of the laminated body in Comparative Example 2, and similar gas accumulation was not confirmed in Example 2. Accordingly, in Example 2, it was confirmed that the gas in the vicinity of the laminated body can be exhausted through the voids allowing communication between the laminated body and the exterior body. FIG. 19 shows charge-discharge curves of Example 2 and Comparative Example 2, and Table 2 shows the discharge capacity and internal resistance of Example 2 and Comparative Example 2. In Comparative Example 2 using the fastening member, the discharge capacity was smaller than in Examples 1 and 2, although the discharge capacity was increased compared to Comparative Example 1. In addition, the internal resistance of Example 2 was smaller than that of Comparative Example 2.

In Comparative Example 2, the cause of the small discharge capacity compared to Examples 1 and 2 and the cause of the large internal resistance compared to Example 2 are thought to be that the gas sealed together with the laminated body during assembly and the gas generated by a reaction of the solid electrolyte and water during charging reduced the adhesion between the laminated body and current collectors.

TABLE 2

| | Example 2 | Comparative Example 2 |
|---|---|---|
| Discharge capacity (mAh) | 0.65 | 0.52 |
| Internal resistance (Ω) | 199 | 236 |

### Example 3-1

An all-solid-state battery was prepared by the same method as in Example 1 except that the thickness T51 of a first adhesive sheet was 50 μm and the thickness T52 of a second adhesive sheet was 50 μm.

### Examples 3-2 to 3-6

All-solid-state batteries were prepared by the same method as in Example 3-1 except that the thickness T40 of an insulation sheet, the thickness T51 of a first adhesive sheet, and the thickness T52 of a second adhesive sheet were changed.

Table 3 summarizes the conditions relating to the thickness T40 of an insulation sheet, the thickness T51 of a first adhesive sheet, and the thickness T52 of a second adhesive sheet, the ratio T51/T52 of the thickness T51 of the first adhesive sheet to the thickness T52 of the second adhesive sheet, the ratio T52/T51 of the thickness T52 of the second adhesive sheet to the thickness T51 of the first adhesive sheet, and the ratio T40/T45 of the thickness T40 of the insulation sheet to the thickness T45 of an insulation unit in each example.

In addition, the discharge capacity and the internal resistance were measured by the same method as in Example 1 for the all-solid-state batteries of Examples 3-1 to 3-6. These measurement results are also summarized in Table 3.

TABLE 3

| | | Example | Example | Example | Example | Example | Example |
|---|---|---|---|---|---|---|---|
| | | 3-1 | 3-2 | 3-3 | 3-4 | 3-5 | 3-6 |
| Thickness (T51) of first | [μm] | 50 | 50 | 50 | 50 | 30 | 5 |
| adhesive sheet | | | | | | | |
| Thickness (T40) of insulation | [μm] | 100 | 100 | 190 | 190 | 200 | 200 |
| sheet | | | | | | | |
| Thickness (T52) of second | [μm] | 100 | 50 | 100 | 50 | 5 | 5 |
| adhesive sheet | | | | | | | |
| Thickness (T10) of laminated | [μm] | 300 | 200 | 370 | 310 | 300 | 300 |
| body | | | | | | | |
| Ratio (T51/T52) | — | 0.5 | 1 | 0.5 | 1 | 6 | 1 |
| Ratio (T52/T51) | — | 2 | 1 | 2 | 1 | 0.167 | 1 |
| Thickness (T45) of insulation | [μm] | 250 | 200 | 340 | 290 | 235 | 210 |
| unit | | | | | | | |
| Ratio (T40/T45) | — | 0.4 | 0.5 | 0.559 | 0.655 | 0.851 | 0.952 |
| Discharge capacity | [mAh] | 0.66 | 0.66 | 0.66 | 0.66 | 0.65 | 0.66 |
| Internal resistance | [Ω] | 315 | 311 | 322 | 316 | 323 | 324 |

### REFERENCE SIGNS LIST

10 Laminated body
11 Positive electrode active material layer
12 Solid electrolyte layer
13 Negative electrode active material layer
14, 16 Lead
15 Current collector
15A Positive electrode current collector
15B Negative electrode current collector
20 Exterior body
22 Metal foil
24 Resin layer
40, 40A, 40C, 40H, 40O Insulation sheet
45 Insulation unit
50, 50A, 50B, 50G, 50H, 50L Adhesive sheet
51A, 51B, 51G First adhesive sheet
52A, 52C, 52G Second adhesive sheet
90 Electrical storage element
100A, 100B, 100C, 100D, 100E, 100F, 100G, 100H, 100I, 100J, 100K, 100L, 100M All-solid-state battery
A Void
H40 Through-hole (of insulation sheet)
H50 Through-hole (of adhesive sheet)

1. An all-solid-state battery comprising:
an exterior body which includes
a laminated body in which a positive electrode active material layer, a solid electrolyte layer, and a negative electrode active material layer are laminated in this order,
a positive electrode current collector and a negative electrode current collector that sandwich the laminated body in a lamination direction,
an insulation sheet that is positioned between the positive electrode current collector and the negative electrode current collector and is positioned in an in-plane direction with respect to the laminated body,
a first adhesive sheet that is positioned between the insulation sheet and the positive electrode current collector and to which at least a part of the insulation sheet and the positive electrode current collector is bonded, and
a second adhesive sheet that is positioned between the insulation sheet and the negative electrode current collector and to which at least a part of the insulation sheet and the negative electrode current collector is bonded,
wherein the laminated body and the exterior body are communicating with respect to each other.

2. The all-solid-state battery according to claim 1,
wherein at least one void is formed in an insulation unit configured to have the first adhesive sheet, the insulation sheet, and the second adhesive sheet, and
wherein the laminated body and the exterior body are communicating with respect to each other through the void.

3. The all-solid-state battery according to claim 2,
wherein the void is formed in at least one of the first adhesive sheet and the second adhesive sheet.

4. The all-solid-state battery according to claim 2,
wherein two voids are formed in the insulation unit, and
wherein the two voids are provided at non-overlapping positions when viewed in a plan view in the lamination direction.

5. The all-solid-state battery according to claim 2,
wherein four voids are formed in the insulation unit, and
wherein the four voids are provided at non-overlapping positions when viewed in a plan view in the lamination direction.

6. The all-solid-state battery according to claim 2,
wherein the width of the voids is smaller than the minimum width of the laminated body when viewed in a plan view in the lamination direction.

7. The all-solid-state battery according to claim 1,
wherein the first adhesive sheet and the second adhesive sheet are provided along an end surface of the insulation sheet on a side close to the laminated body.

8. The all-solid-state battery according to claim 2,
wherein the voids are formed in the first adhesive sheet, the insulation sheet, and the second adhesive sheet at overlapping positions when viewed in a plan view in the lamination direction.

9. The all-solid-state battery according to claim 1,
wherein the first adhesive sheet includes a plurality of adhesive sheets provided apart from each other in different orientations with respect to the laminated body, and
wherein the second adhesive sheet includes a plurality of adhesive sheets provided apart from each other in different orientations with respect to the laminated body.

10. The all-solid-state battery according to claim 1,
wherein a space between the positive electrode current collector and the negative electrode current collector in a region overlapping the first adhesive sheet is smaller than a space between the positive electrode current collector and the negative electrode current collector in a region overlapping the laminated body.

11. The all-solid-state battery according to claim 1,
wherein the first adhesive sheet and the insulation sheet surround a periphery of the laminated body in the in-plane direction, and
wherein, in the plan view from the lamination direction of the laminated body, a shape of an inner circumference of the insulation sheet on the side close to the laminated body is similar to or congruent with a shape of an inner circumference of any of the first adhesive sheet or the second adhesive sheet on the side close to the laminated body.

12. The all-solid-state battery according to claim 1,
wherein the first adhesive sheet, the second adhesive sheet, and the insulation sheet surround the periphery of the laminated body in the in-plane direction, and
wherein, when viewed in the lamination direction of the laminated body, the dimensions of the inner circumference of the first adhesive sheet and the second adhesive sheet surrounding the laminated body are less than or equal to the dimensions of the inner circumference of the insulation sheet surrounding the laminated body.

13. The all-solid-state battery according to claim 1,
wherein the relationship between a thickness T40 of the insulation sheet and a total thickness T45 of the insulation sheet, the first adhesive sheet, and the second adhesive sheet satisfies Expression [1] below,
$$0.3 \leq T 40 / T 45 \leq 0.96 \underline{.} \qquad [ 1 ]$$

14. The all-solid-state battery according to claim 13,
wherein the ratio T51/T52 of a thickness T51 of the first adhesive sheet to a thickness T52 of the second adhesive sheet satisfies a relationship of Expression [2] below,
$$0.15 \leq T 51 / T 52 \leq 7 \underline{.} \qquad [ 2 ]$$

15. The all-solid-state battery according to claim 13,
wherein the thickness T51 of the first adhesive sheet is 4 to 110 μm.

16. The all-solid-state battery according to claim 13,
wherein the thickness T52 of the second adhesive sheet is 4 to 110 μm.
